(19) United States
(12) Patent Application Publication
(10) Pub. No.: US 2009/0293356 A1
(43) Pub. Date: Dec. 3, 2009

(54) SYSTEM AND METHOD FOR TYING CLIMB STRINGS ESPECIALLY FOR CLIMBING PLANTS

(76) Inventor: Wolfgang Richter, Starnberg (DE)

Correspondence Address: K.F. ROSS P.C., 5683 RIVERDALE AVENUE, SUITE 203 BOX 900, BRONX, NY, 10471-0900, US

(21) Appl. No.: 12/295,402

(22) PCT Filed: Jan. 31, 2007
(86) PCT No.: PCT/EP07/00831

§ 371 Date: Nov. 25, 2008

(30) Foreign Application Priority Data
Jan. 31, 2006 (DE) 102006004369.3

(51) Int. Cl. A01G 17/08; G01B 7/14; A01G 1/00

(52) U.S. Cl. 47/1.1 S; 47/58.1 R

(57) ABSTRACT

The invention relates to a system and a method for tying climb strings especially for climbing plants. Such climb strings are used particularly in hop growing in the form of plastic strings or metal wires. The aim of the invention is to be able to tie plant climb strings more efficiently than in prior art. Said aim is achieved by a system for tying plant climb strings to guide wires, said system comprising: a traveling gear device; an arm structure that is coupled to the traveling gear device; a device for supplying the plant climb strings; a tying unit which is fastened to the mast structure and is used for tying the plant climb string to a selected section of the guide wire; a device for detecting the guide wire; and a manipulating device for adjusting the position of the tying unit relative to the guide wire. The detecting device is configured so as to detect the position of the guide wire in a contactless fashion.

The invention relates to a system and to a method of tying climb strings especially for climbing plants. Climb strings of this type are used in the form of plastic strings or metal wires, in particular in the field of hop cultivation.

In the cultivation of hops, hop plants grow up climb strings anchored on the ground and are usually formed by metal wires or more recently in particular as biodegradable plastic strings. These climb strings are attached at their upper ends to a guide wire usually formed by a barbed wire and stretched on poles longitudinally over the corresponding cultivation field and stabilized by horizontal guy wires. During harvest the hop plants are removed with their climb string. For the subsequent new planting, a new climb string must be stretched for each plant and thereby attached to the respective horizontal wire.

The attachment can be carried out with mechanical support by a tying device mounted on a tractor, as known from DE 199 22 655. The tractor can sway considerably, in particular with relatively soft or uneven field soil, and the tying device can deviate inadmissibly far from the upper guide wire so that the tying device does not reach the guide wire and grasps at thin air. Considerable deviations of the tying device with respect to the guide wire also occur when the horizontal wires or guide wires sag.

The object of the invention is to provide solutions that render possible a more efficient tying of plant climb strings compared to previous concepts.

This object is attained according to a first aspect of the invention through a system for tying plant climb strings to guide wires with:

a movable vehicle,

an arm structure coupled to the movable vehicle,

a device for supplying a plant climb string,

a tying unit attached to the arm structure for tying the plant climb string to a selected section of the guide wire,

a detecting device for detecting the guide wire, and

a manipulating device for adjusting the relative position of the tying unit with respect to the guide wire,

wherein the detecting device comprises an electrode assembly and a signal-conditioning circuit coupled to the electrode assembly and this signal-conditioning circuit is configured such that indicative information is collected regarding the position of the guide wire with regard to the electrode assembly based on electrical field influences of the guide wire on the electrode assembly.

It is thus possible in an advantageous manner to detect the position of the guide wire in a contactless manner with a high degree of validity and to position the tying unit sufficiently near to the guide wire.

The detecting device can be formed by a fully sealed and thus sturdy and rugged unit. The position correction of the tying unit can be carried out in a fully automatic or partially automatic manner. It is possible to display the position of the guide wire to a machine operator and to give him room for suitable course corrections or at least correction contributions that can optionally be initiated manually. It is possible to carry out the necessary positioning of the tying unit with respect to the guide wire by several adjusting actions. It is thus possible to keep the movable vehicle itself on course roughly by steering turns and optionally by changing the steering setting.

Rough alignment of the arm can be carried out by influencing the adjustment of the arm connection to the carrier device. Fine positioning of the tying unit can be carried out with high dynamics and relatively low operating forces, in that the tying unit can be repositioned with respect to the arm. Preferably the system is continuously adjusted such that positioning of the tying unit is achieved with a favorable overall system adjustment.

Preferably a sensor system is attached to the arm and is able to measure an electrical alternating field at several points in its signal strength. This field is also capacitively calibrated to the guide wire formed by barbed wire through a suitable electronic system so that a contactless measurement is possible. An electronic circuit compares the measured level to a reference value and reports possible deviations to a control device that can readjust the arm electromechanically, hydraulically, pneumatically, etc. Furthermore, it is optically displayed to the driver of a tractor whether he is close enough with his vehicle to or at the right distance from the barbed wire attached, e.g. in Germany at a height of 7.20 m.

Preferably the electrode assembly has several detecting electrodes spaced apart from one another spatially. Furthermore, the detecting device preferably comprises at least one feed electrode for coupling an alternating field into the vicinity area of the guide wire.

The data corresponding to the position of the guide wire with respect to the electrode assembly can be obtained by evaluating the voltage applied to the electrode assemblies. It is also possible to obtain the data corresponding to the position of the guide wire with respect to the electrode assembly by evaluating the voltage building up at the electrode assemblies.

The data corresponding to the position of the guide wire with respect to the electrode assembly can also be obtained in particular in combination with the above-described measures based on changes in capacitance of the capacitor devices formed including the respective electrode assemblies. This change in capacitance of the capacitor devices can be detected based on changes in the resonant circuit. The oscillation frequency of the capacitor system formed including the respective electrode assembly can be evaluated as distance information of the horizontal wire with respect to the electrode assembly.

Preferably the detecting device is coupled with the tying unit. The observation radius of the detecting device is preferably much greater than the guide wire deviation radius tolerated by the tying device.

The manipulating device can be incorporated into a coupling structure via which the arm structure is coupled to the movable vehicle. Furthermore, the manipulating device can also be incorporated into a coupling structure via which the tying unit is coupled to the arm structure. Preferably control of the manipulating device is carried out in compliance with a recorded relative position of the guide wire with respect to a reference system.

The electrode assemblies are preferably arranged such that a detecting of the wires results that is favorable with respect to a typical design of the upper guide wire setup.

### BRIEF DESCRIPTION OF THE DRAWINGS

Further details and features of the invention are shown by the following description in connection with the drawing. Therein:

FIG. 1 is a diagrammatic representation showing the design of a detecting device according to the invention with several detecting electrodes spaced apart with respect to one another, as well as a feed electrode;

FIG. 2 is a diagrammatic representation showing the design of a signal generator;

FIG. 3 is a diagrammatic representation showing the design of a multiplexer variant of a detecting device according to the invention with several detecting electrodes spaced apart from one another spatially;

FIG. 4 is a diagrammatic representation showing the design of a detecting device according to the invention relative to a barbed wire.

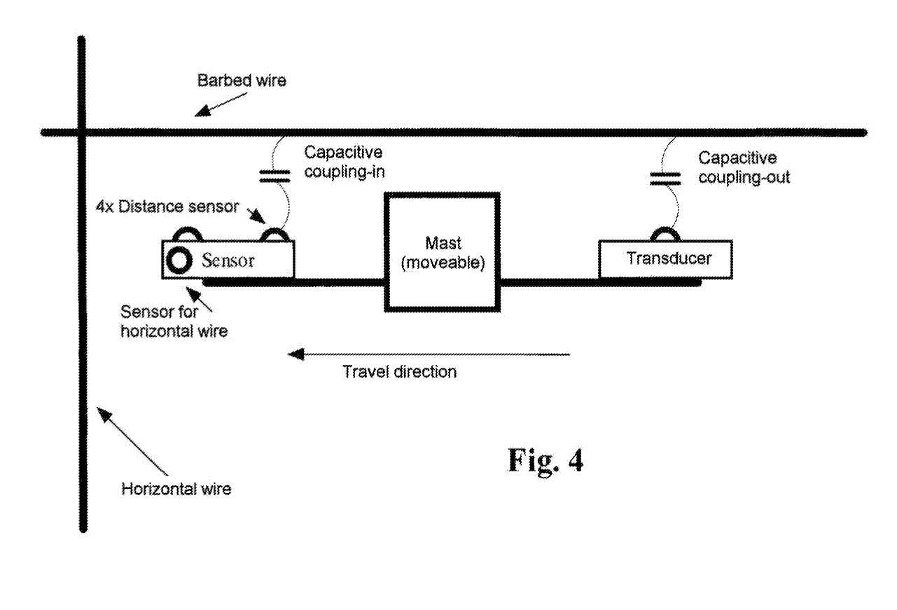

### SPECIFIC DESCRIPTION OF THE INVENTION IN CONNECTION WITH THE DRAWING

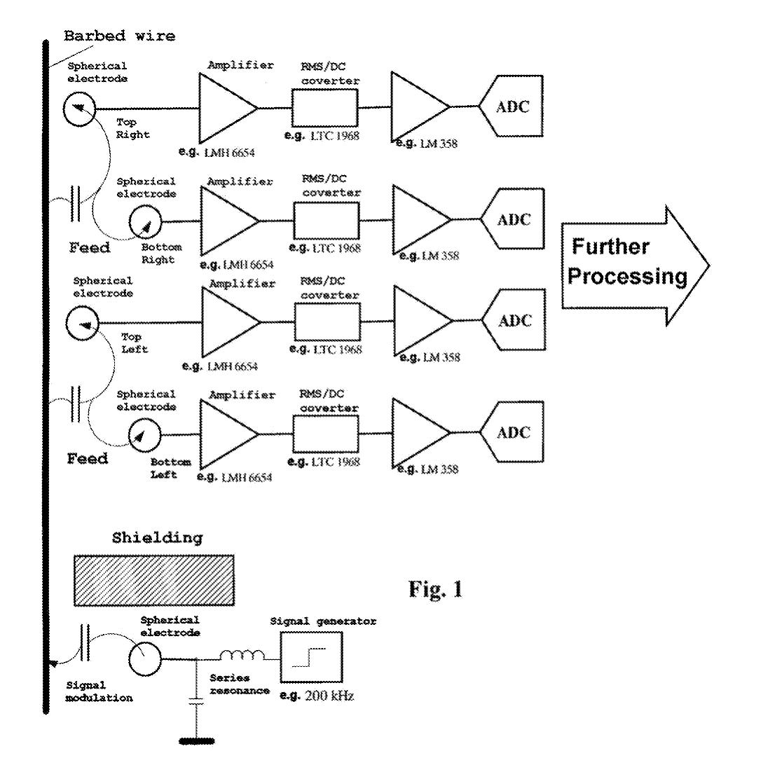

FIG. 1 shows the reception of a signal (e.g. 200 kHz) in a capacitive manner with a spherical electrode. The signal is amplified and fed to a level converter (here RMS/DC) that at its output generates a DC voltage signal that corresponds to the measured and amplified level. A downstream buffer circuit feeds this signal to an analog-digital converter that digitizes it. This arrangement is duplicated so that at least four points are provided in order to detect direction changes and proximity to a barbed wire. To make this possible, this must be acted on with a signal. This is possible in two ways. In the direct way an AC voltage signal is coupled with a definable output level directly to the wire. Since all of the wires are connected to one another, this can be effected at a central point. Another possibility is to guide the output signal on the arm and capacitively calibrate to a barbed wire on nearing same. Since this is lossy, the level must be accordingly high.

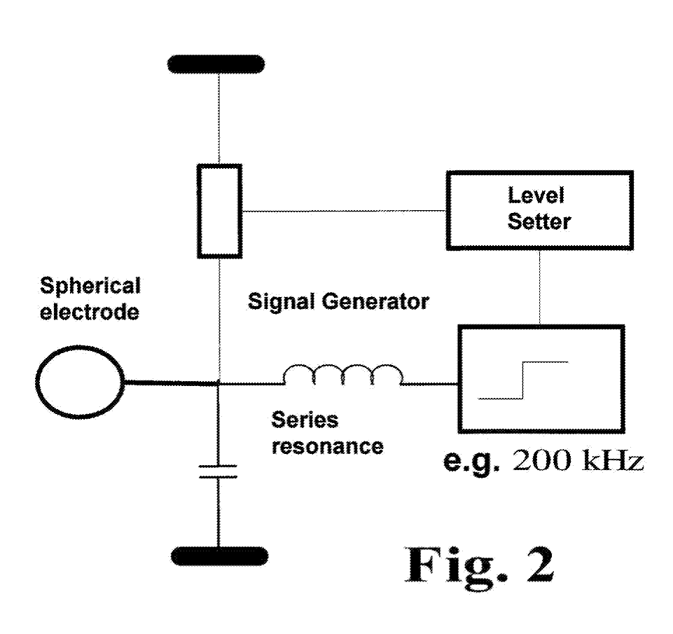

FIG. 2 shows a corresponding transducer circuit. This is essentially an oscillator that can increase its output voltage with a series-resonance circuit. At a high impedance resistance this voltage can be measured with the aid of a voltage part and possibly fed to a control circuit.

### EXPANDED EMBODIMENT

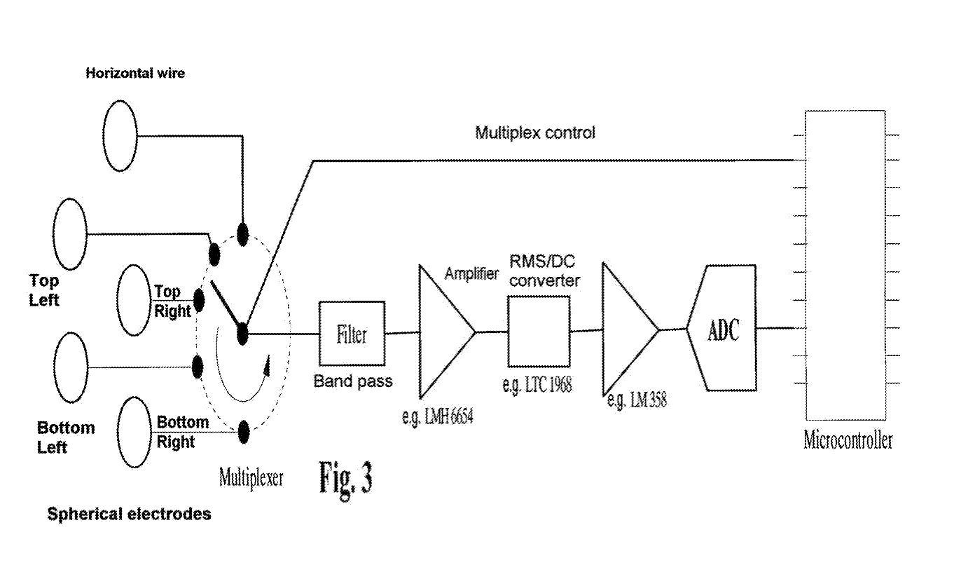

In order to save on component costs, it is advantageous to scan the electrodes of the measuring circuit individually one after the other. This can be carried out by a multiplexer (FIG. 3).

The scanned signal is then tested according to its signal strength in the described manner.

Exemplary Control

In order for it to be possible for the measuring circuit to be evaluated in a timely manner, it is acted on with a microprocessor. The analog-digital converter necessary for digitization can also be located therein. Moreover, there is a communication connection for the mast arm control. The control there can now scan the status with the aid of simple commands. These are: numerical values from 1 through 9. The emission of a number of this type (e.g., maski code) makes it possible to scan an individual sensor. The value measured by the ADC is transmitted to the control and can be evaluated there.

With the command “S” all of the sensors can be scanned in a definable order.

The command “P” permits the scanning of the percentage change values of all of the sensors. In addition, the circuit supplies a signal whenever a previously described horizontal wire comes close to the sensor element. This could be a “Q” for example. For safety reasons this is sent cyclically as long as the arm is located in the danger zone of a horizontal wire and its outrigger may not be actuated. Once the last danger point has been passed, the sensor device transmits cyclically for example a “W” (for working) in order to tell the control that it can carry out its operations without risk of danger.

Finally, a reference point can be established with the command “R.” To this end the arm is brought into the correct proximity of a barbed wire and the R command is given. The reference value is determined and stored. After each P command data from all sensors are measured and compared to the reference points and their percentage deviation from the control (SPS) is transmitted.

Further Particular Embodiments of the Invention

It is possible to regulate the level of the output signal transducer in order to guarantee a safe impressing of the AC voltage signal on the barbed wire. Furthermore, it is possible to increase the functional scope of the measuring circuit by simple expansion of additional measuring points. It is also possible to expand the microprocessor in its functional scope in the measuring circuit by additional commands (flash controller). This could be, for example, the interrupt control of the outrigger in order to prevent the SPS from “overlooking” a reported horizontal wire. A cycle command is also conceivable that can adapt the measuring speed to the travel speed of the tractor. Furthermore, it is possible to operate the steering wheel of the tractor via a suitable servo motor in order to automatically stay on track. In an expanded embodiment the microprocessor of the sensor circuit can also take over the outrigger control of the arm and the relieve or render superfluous an SPS.

The Physical Active Principle

This is an AC voltage circuit in which an oscillator generates a high-voltage alternating field of average frequency (approx. 200 kHz) and emits it via a spherical electrode. A (barbed) wire located in the vicinity forms the other electrode and receives the electric field and passes it on so that an attenuation (i.a., also with respect to ground) takes place. The signal acted on is taken up at another point by several electrodes that are located at different positions relative to the wire acted on by the signal. Now each one takes up a signal level that corresponds proportionately to its distance from the wire. Amplification allows the signal to further process more safely. In order to eliminate interference signals, a filter (bandpass), resonant circuit, active, passive, can also be carried out upstream of an amplifier. After amplification, the level is established. This can be carried out by a peak-reading detector or by an RMS to DC converter, the latter being preferred for the following reason:

The movement on the barbed wire generates a modulated field that is produced by the special features of the barbed wire. This is twisted and provided with barbs, i.e. its mass is not always homogenous along its length. RMS to DC converters have a capacitor at their output in order to establish the average of an effective value and do not react or react hardly at all to brief fluctuations, which is of particular importance for the invention. At the output of the conversion a DC voltage is formed that can be amplified by buffers and measured. This is advantageously carried out by a downstream analog-digital (AD) converter. From now on the further processing of the signal is carried out digitally, which permits computational operations. The relationship of the signals to one another is thus determined and fed to an evaluation device.

An array of preferably four sensors can be attached (in the travel direction) on a clamping arm near the upper end. This is necessary in order to recognize horizontal wires before the outriggers of the mast can touch them. At the rear end of the mast the transducer-oscillator is attached with at least one electrode (preferably spherical). The spacing should be selected such that a barbed wire to be monitored is closer than the sensor element on the mast arm. Shielding, e.g. a grounded shield, may have to ensure that the signal does not reach the receiving electrode through the air and the measuring result is thus distorted. Additional electrodes can be attached to the upper end of the measuring device in order to be able to safely recognize a horizontal wire. However, the upper two measuring electrodes can also be used, which determine a (possible) shear angle to the wire.

Based on the spacing conditions detected continuously via the sensors, the relative position of the sensor device can be detected with respect to the horizontal wire. Based on the relative position thus established, arm alignment can be adjusted so that a climb string application head is located sufficiently close to the horizontal wire. In this position a tying process can be initiated. It is possible during this tying to move the carrier vehicle farther and to take into account the change of the relative position of the carrier vehicle with respect to the horizontal wire or the tying position by monitored control of the arm structure. The movement of the carrier vehicle can be detected by acceleration sensors, in particular gyroscopes or image processing systems and used for roll steering of the lift arm.

1. A system for tying plant climb strings to guide wires, the system comprising:
a movable vehicle,
an arm structure coupled to the movable vehicle,
a device for supplying the plant climb strings,
a tying unit attached to the arm structure for tying the plant climb strings to a selected section of the guide wire,
a detecting device for detecting the guide wire in a contactless manner, and
a manipulating device for adjusting the relative position of the tying unit with respect to the guide wire.

2. The system according to claim 1 wherein the detecting device comprises an electrode assembly and a signal-conditioning circuit coupled to the electrode assembly and this signal-conditioning circuit is configured such that indicative information is collected regarding the position of the guide wire with regard to the electrode assembly based on electrical field influences of the guide wire on the electrode assembly.

3. The system according to claim 1 wherein the electrode assembly comprises several detecting electrodes spaced apart from one another spatially.

4. The system according to claim 2 wherein the electrode assembly comprises at least one feed electrode for coupling an alternating field into the vicinity area of the guide wire.

5. The system according to claim 2 wherein data corresponding to the position of the guide wire with respect to the electrode assembly is obtained by evaluating the voltage applied to the electrode assemblies.

6. The system according to claim 2 wherein the data corresponding to the position of the guide wire with respect to the electrode assembly is obtained by evaluating the voltage building up at the electrode assemblies.

7. The system according to claim 2 wherein the data corresponding to the position of the guide wire with respect to the electrode assembly is obtained based on changes in capacitance of the capacitor devices formed including the respective electrode assemblies.

8. The system according to claim 2 wherein the change in capacitance of the capacitor devices are detected based on resonant circuit frequency changes.

9. The system according to claim 2 wherein the oscillation frequency of the capacitor system formed including the respective electrode assembly is evaluated as distance information of the horizontal wire with respect to the electrode assembly.

10. The system according to claim 1 wherein the detecting device is coupled with the tying unit.

11. The system according to claim 1 wherein the manipulating device is incorporated into a coupling structure via which the arm structure is coupled with the movable vehicle.

12. The system according to claim 1 wherein the manipulating device is incorporated into a coupling structure via which the tying unit is coupled to the mast structure.

13. The system according to claim 1 wherein the manipulating device is incorporated into the movable vehicle.

14. The system according to claim 1 wherein the control of the manipulating device is carried out in compliance with a recorded relative position of the horizontal wire with respect to a reference system.

15. A method of tying plant climb strings to guide wires by means of a tying unit that can be guided via an arm structure up to those guide wires, wherein the position of the guide wires is detected in a contactless manner by means of a detecting device provided near the tying unit.
